(19) United States
(12) Patent Application Publication
(10) Pub. No.: US 2026/0304295 A1
(43) Pub. Date: Oct. 1, 2026

(54) COORDINATION BETWEEN APS TO PERFORM SELECTIVE CHANNEL SOUNDINGS

(71) Applicant: Samsung Electronics Co., Ltd., Suwon-si (KR)

(72) Inventors: Bilal Sadiq, Plano, TX (US); Vishnu Vardhan Ratnam, Frisco, TX (US); Yue Qi, Plano, TX (US); Peshal Nayak, Plano, TX (US); Rubayet Shafin, Frisco, TX (US); Boon Loong Ng, Plano, TX (US)

(21) Appl. No.: 19/560,977

(22) Filed: Mar. 9, 2026

Related U.S. Application Data
(60) Provisional application No. 63/778,129, filed on Mar. 26, 2025.

(51) Int. Cl. H04W 48/08; H04W 16/14; H04W 72/27

(52) U.S. Cl. CPC H04W 48/08; H04W 16/14; H04W 72/27

(57) ABSTRACT

Methods and systems for coordination between access points to perform selective channel soundings. A method includes transmitting a first frame to a second AP device, the first frame indicating that at least one of a first cross-basic service set (BSS) sounding of the first AP device and a second cross-BSS sounding of the second AP device is requested by the first AP device. The method also includes receiving a second frame from the second AP device, the second frame indicating acceptance of at least one of the first cross-BSS sounding and the second cross-BSS sounding requested in the first frame.

### CROSS-REFERENCE TO RELATED APPLICATIONS AND CLAIM OF PRIORITY

The present application claims priority to U.S. Provisional Patent Application No. 63/778,129, filed on Mar. 26, 2025. The contents of the above-identified patent document is incorporated herein by reference.

### TECHNICAL FIELD

The present disclosure relates generally to wireless communication systems. More specifically, the present disclosure relates to systems and methods for coordination between access points to perform selective channel soundings.

### BACKGROUND

Two or more access points (APs) may coordinate their operation, such as downlink (DL) transmissions to their respective non-AP stations (STAs). By using coordination techniques such as coordinated beamforming (CoBF) and coordinated spatial reuse (CoSR), the coordinating APs simultaneously transmit to their respective STAs on (at least partially) overlapping channels in such a way that interference from one AP's transmission to that of other AP's STAs is minimized.

### SUMMARY

The present disclosure relates generally to wireless communication systems and, more specifically, the present disclosure relates to systems and methods for coordination between access points to perform selective channel soundings.

In one embodiment, a method performed by an access point (AP) device is provided. The method includes transmitting a first frame to a second AP device, the first frame indicating that at least one of a first cross-basic service set (BSS) sounding of the first AP device and a second cross-BSS sounding of the second AP device is requested by the first AP device. The method also includes receiving a second frame from the second AP device, the second frame indicating acceptance of at least one of the first cross-BSS sounding and the second cross-BSS sounding requested in the first frame.

In another embodiment, a method performed by a second AP is provided. The method includes receiving a first frame from a first AP device, the first frame indicating that at least one of a first cross-BSS sounding of the first AP device and a second cross-BSS sounding of the second AP device is requested by the first AP device. The method also includes transmitting a second frame to the first AP device, the second frame indicating acceptance of at least one of the first cross-BSS sounding and the second cross-BSS sounding requested in the first frame.

In yet another embodiment, an first AP device is provided. The first AP device includes at least one processor including processing circuitry and a memory storing instructions. The instructions, when executed by the at least one processor individually or collectively, cause the first AP device to transmit a first frame to a second AP device, the first frame indicating that at least one of a first cross-basic service set (BSS) sounding of the first AP device and a second cross-BSS sounding of the second AP device is requested by the first AP device. The instructions, when executed by the at least one processor individually or collectively, further cause the first AP device to receive a second frame from the second AP device, the second frame indicating acceptance of at least one of the first cross-BSS sounding and the second cross-BSS sounding requested in the first frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP device according to embodiments of the present disclosure;

FIG. 2B illustrates an example STA according to embodiments of the present disclosure;

FIG. 3 illustrates an example multi-AP coordination diagram supporting cross-basic service set (BSS) channel sounding according to embodiments of the present disclosure;

FIG. 4 illustrates an example cross-BSS channel sounding transmission diagram supporting coordination between access points to perform selective channel soundings according to embodiments of the present disclosure; and

FIG. 5 illustrates an example flow chart of a method for coordination between access points to perform selective channel soundings according to embodiments of the present disclosure.

### DETAILED DESCRIPTION

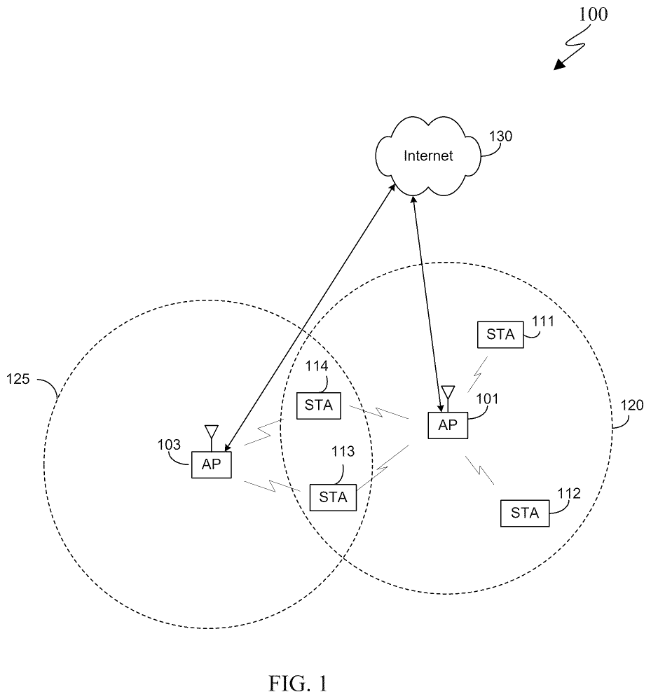

FIG. 1 through FIG. 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, two or more APs may coordinate their operation, such as DL transmissions to their respective non-AP STAs. By using coordination techniques such as CoBF and CoSR, the coordinating APs simultaneously transmit to their respective STAs on (at least partially) overlapping channels in such a way that interference from one AP's transmission to that of other AP's STAs is minimized. Such coordination techniques typically require each AP to sound the channel to one or more STAs associated with the other AP. This is called cross-BSS channel sounding and requires coordination between APs.

Accordingly, the present disclosure provides systems and methods for coordination between access points to perform selective channel soundings. As described herein, the present disclosure includes systems and methods where each AP may indicate to the other AP which soundings it is requesting. This may be done using (sounding) invite and (sounding) response frames, or using null data packet announcement (NDPA) frames.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP device MLDs. Each MLD is affiliated with more than one STA. For convenience of explanation, an AP device MLD is described herein as affiliated with more than one AP device (e.g., more than one AP device STA), and a non-AP device MLD is described herein as affiliated with more than one STA (e.g., more than one non-AP device STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for facilitating coordination between access points to perform selective channel soundings. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

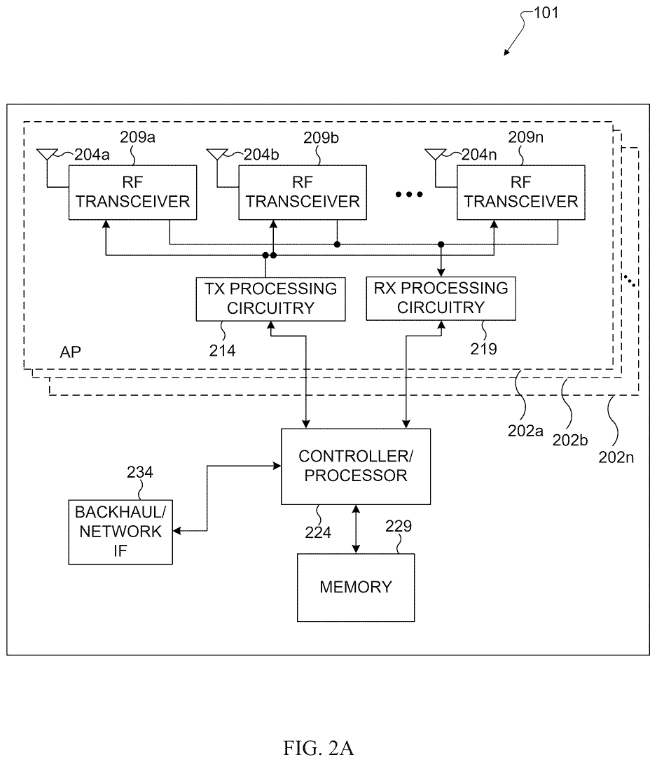

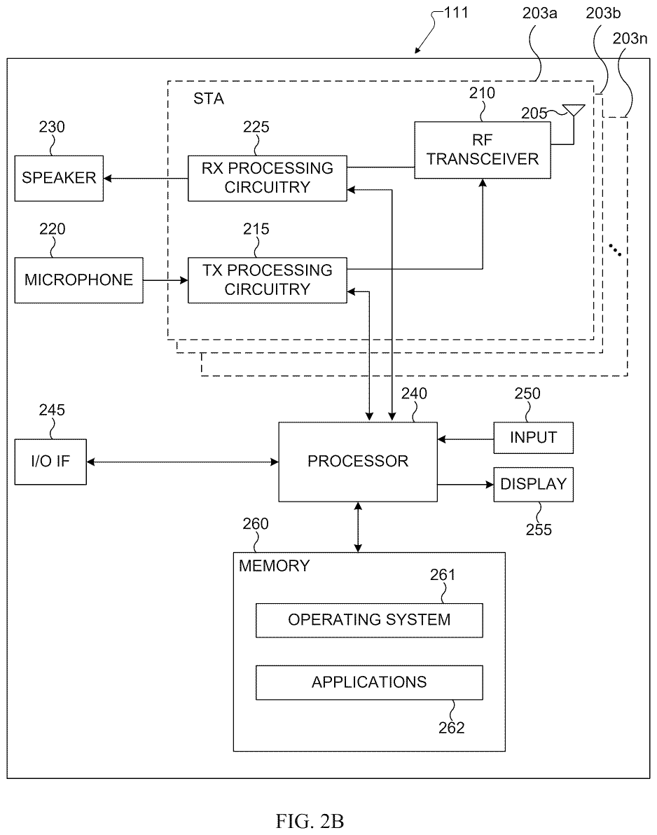

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed herein below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHz, or 6 GHz, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202 a-202n operates at a different bandwidth, e.g., 2.4 GHz, 5 GHz, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP device MLD 101 by the controller/processor 224 including facilitating coordination between access points to perform selective channel soundings. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for coordination between access points to perform selective channel soundings. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example non-AP device MLD 111 according to various embodiments of this disclosure. The embodiment of the non-AP device MLD 111 illustrated in FIG. 2B is for illustration only, and the STAs 111-115 of FIG. 1 could have the same or similar configuration. In the embodiments discussed herein below, the STA 111 is a non-AP device MLD. However, STAs come in a wide variety of configurations, and FIG. 2B does not limit the scope of this disclosure to any particular implementation of a STA.

The non-AP device MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP device MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP device MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP device MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate coordination between access points to perform selective channel soundings. In some embodiments, the controller/processor 240 includes at least one microprocessor or microcontroller.

The processor 240 is also capable of executing other processes and programs resident in the memory 260, such as operations for facilitating coordination between access points to perform selective channel soundings. The controller/processor 240 can move data into or out of the memory 260 as required by an executing process. In some embodiments, the controller/processor 240 is configured to execute a plurality of applications 262, such as applications for facilitating coordination between access points to perform selective channel soundings. The controller/processor 240 can operate the plurality of applications 262 based on the OS program 261 or in response to a signal received from an AP device. The main controller/processor 240 is also coupled to the I/O interface 245, which provides non-AP device MLD 111 with the ability to connect to other devices such as laptop computers and handheld computers. The I/O interface 245 is the communication path between these accessories and the main controller 240.

The processor 240 is also coupled to the touchscreen 250 and the display 255. The operator of the non-AP device MLD 111 can use the touchscreen 250 to enter data into the non-AP device MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP device MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP device 101. In another example, the non-AP device MLD 111 may not include voice communication or the controller/processor 240 could be divided into multiple processors, such as one or more central processing units (CPUs) and one or more graphics processing units (GPUs). Also, while FIG. 2B illustrates the non-AP device MLD 111 configured as a mobile telephone or smartphone, non-AP device MLDs can be configured to operate as other types of mobile or stationary devices.

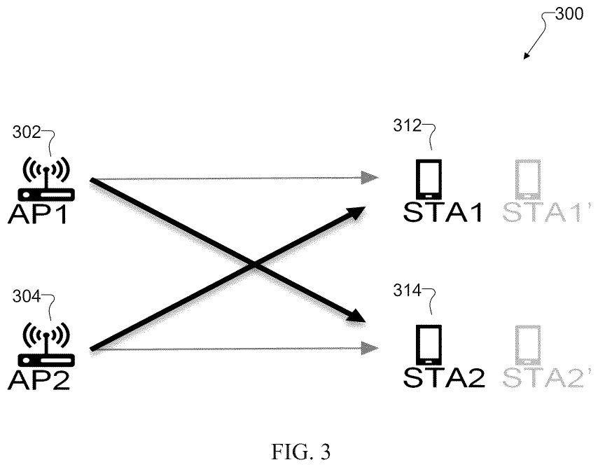

FIG. 3 illustrates an example multi-AP coordination diagram 300 supporting cross-basic service set (BSS) channel sounding according to embodiments of the present disclosure. The multi-AP coordination diagram 300 may include one or more components of the wireless network 100 of FIG. 1, such as the APs 101, 103 and the STAs 111-114. The embodiment of the multi-AP coordination diagram 300 shown in FIG. 3 is for illustration only. Other embodiments of the multi-AP coordination diagram 300 could be used without departing from the scope of this disclosure.

As shown in FIG. 3, two or more APs, such as AP1 302 and AP2 304, may coordinate their operation, such as DL transmissions to their respective non-AP STAs 312, 314. By using coordination techniques such as CoBF and CoSR, the coordinating APs simultaneously transmit to their respective STAs on (at least partially) overlapping channels in such a way that interference from one AP's transmission to that of other AP's STAs is minimized. Such coordination techniques typically require each AP to sound the channel to one more STAs associated with the other AP. This is called cross-BSS channel sounding and requires coordination between APs.

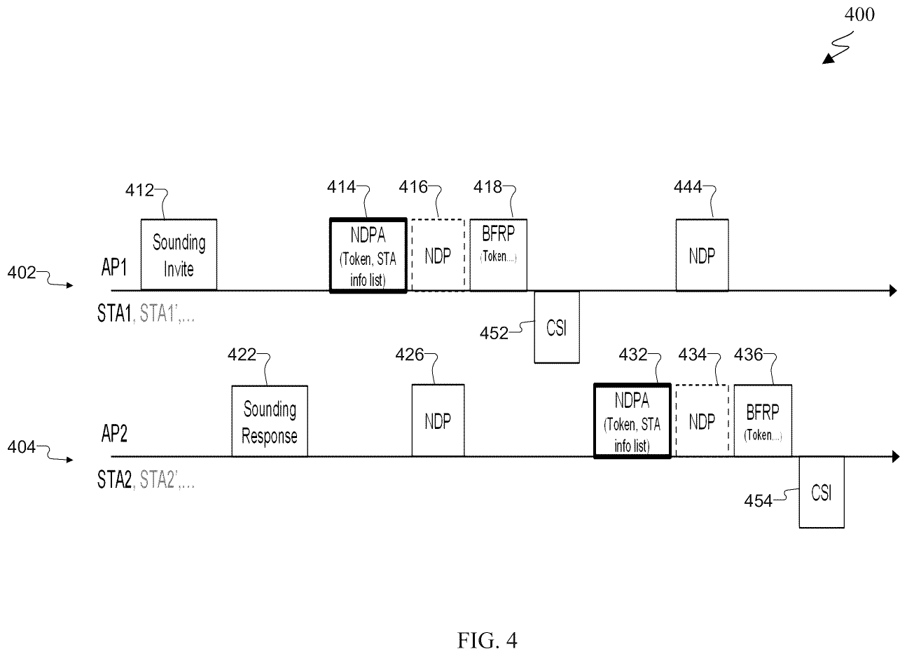

FIG. 4 illustrates an example cross-BSS channel sounding transmission diagram 400 supporting coordination between access points to perform selective channel soundings according to embodiments of the present disclosure. The cross-BSS channel sounding transmission diagram 400 may include one or more components of the wireless network 100 of FIG. 1, such as the APs 101, 103 and the STAs 111-114. The embodiment of the cross-BSS channel sounding transmission diagram 400 shown in FIG. 4 is for illustration only. Other embodiments of the cross-BSS channel sounding transmission diagram 400 could be used without departing from the scope of this disclosure.

As shown in FIG. 4, the cross-BSS sounding transmission diagram 400 includes transmission between a first AP device 402 and a second AP device 404. The first AP device 402 may transmit a sounding invitation 412 to the second AP device 404, which may provide a sounding response 422 to accept or reject the sounding invitation 412. The first AP device 402 may then transmit a first announcement frame, such as a null data packet announcement (NDPA) frame 414 to announce the sounding to its associated STA(s) (e.g., STA1, STA1′) and additionally asks the second AP device 404 (unassociated with the STAs of the first AP device 402) to participate in the sounding as an AP. The second AP device 404 may then transmit at least a part of a sounding signal NDP 426. When both the first AP device 402 and the second AP device 404 transmit NDP (416, 426)-e.g., spatial streams 1-4 transmitted by the first AP device 402 and spatial streams 5-8 transmitted by the second AP device 404—such a sounding is referred to as joint sounding. In this case, cross-BSS and in-BSS sounding is accomplished jointly. The STAs (STA1, STA1′) perform the channel measurement requested in the NDPA frame and subsequently report the channel measurement 452 to their associated AP (the first AP device 402). In some cases this measurement report may be simultaneously received by the second AP device 404 or forwarded to the second AP device 404 by the first AP device 402. At this point, the second AP device 404 has sounded the channel between one or more STAs associated with the first AP device 402.

Then the process is repeated with the two AP devices switching roles. For example, the second AP device 404 may transmit a second NDPA 432 to announce the sounding to its associated STA(s) (e.g., STA2, STA2′) and additionally asks the first AP device 402 (unassociated with the STAs of the second AP device 404) to participate in the sounding as an AP, then at least a part of the sounding signal NDP 444 may be transmitted by the first AP device 402 on which the STAs perform channel measurement and subsequently report the channel measurement 454 to their associated AP (the second AP device 404). As described above, this sounding may be joint (both APs transmitting an NDP 434, 444 simultaneously) or exclusively cross-BSS.

As described herein, the cross-BSS portion of the sounding requires coordination between APs. The cross-BSS sounding that is started by the first AP device 402 sending the NDPA—i.e., sounding the channel between the second AP device 404 and the STA(s) associated with the first AP device 402—is referred to herein as AP1's cross-BSS sounding. Similarly, the cross-BSS sounding that is started by the second AP device 404 sending the NDPA—i.e., sounding the channel between the first AP device 402 and the STA(s) associated with the second AP device 404—is referred to herein as AP2's cross-BSS sounding.

It should be noted that AP1's cross-BSS soundings may often be needed at different times and with different cadence than AP2's cross-BSS soundings. For example, the cadence of AP1's cross-BSS soundings may be determined by the mobility of the first AP device's STA (the STA associated with the first AP device 402). The higher the mobility, the faster the channel changes and hence more frequent sounding may be needed. This is similar to how an AP determines the cadence of in-BSS sounding based on how fast its associated STA's channel is changing. Therefore, the first AP device 402 may also determine how frequently its cross-BSS sounding is needed. Moreover, based on the success/failure of past coordinated transmission, the first AP device 402 may determine how often its cross-BSS channel needs to be re-sounded to effectively mitigate cross-BSS interference. In summary, each AP may determine when its own cross-BSS sounding is needed, and the two cross-BSS soundings may often be needed at different times and with different cadence.

In addition, it should be noted that sometimes the second AP device 404 may need to request AP1's cross-BSS sounding and vice versa. For example, if the second AP device 404 could not decode a previous channel measurement report from AP1's cross-BSS sounding (transmitted by a STA associated with AP1). Or the second AP device 404 purged a previous channel measurement report due to memory limitations or its implementation-dependent timeout for how long a past channel measurement is considered valid. So, one AP's cross-BSS sounding may sometimes be initiated by the AP itself, and other times, requested by the other AP.

This disclosure presents techniques to make the cross-BSS channel sounding transmission diagram 400 more flexible in supporting coordination between access points to perform selective channel soundings.

Each AP may indicate to the other AP which soundings it is requesting. This may be done using (sounding) invite and (sounding) response frames, or using NDPA frames.

As an illustrative, non-limiting example, suppose the AP sending the invite frame is designated AP1 and the AP receiving the invite frame and sending the response frame is designated AP2.

Request 1: In one embodiment, AP1 (the AP sending the invite frame) may indicate in the invite frame a request for AP2 to perform AP1's cross-BSS sounding.
i. AP1's cross-BSS sounding, as also described previously, may include AP1 sending an NDPA, in response to which the AP2 will send an NDP, and possibly AP2 subsequently attempting to receive the channel measurement report from one or more STAs associated with AP1.
ii. The request may be indicated using 1 bit (Yes/No) in the invite frame.

Request 2: In one embodiment, AP1 may indicate in the Invite frame a request for AP2 to perform AP2's cross-BSS sounding.
i. AP2's cross-BSS sounding, as also described previously, may include AP2 sending an NDPA, in response to which the AP1 will send an NDP, and possibly AP1 subsequently attempting to receive the channel measurement report from one or more STAs associated with AP2.
ii. The request may be indicated using 1 bit in the Invite frame. Setting the bit may indicate that AP1 is requesting a repeat of AP2's previous cross-BSS sounding, or that AP1 could not decode (at least one) channel measurement report corresponding to the AP2's previous cross-BSS sounding.
   a. After receiving this indication, should AP2 accept the request, it may be left up to AP2 to determine whether to repeat cross-BSS sounding with the (at least some of the) same STAs that were included in the previous cross-BSS sounding, or to pick different STAs for cross-BSS sounding. For example, AP2 may use current buffer status or in-BSS channel conditions to determine which STAs to select for its cross-BSS sounding. The indication from AP1 still serves an important purpose to let AP2 know that (at least some) channel measurements corresponding to AP2's previous cross-BSS sounding may be missing at AP1.
   b. Such a request should be made by the AP1 (Inviting AP) within a reasonable time of the AP2's “failed” cross-BSS sounding. For example, within 20TUs. This is because AP1 may not be expected to remember which associated STAs it had for its last cross-BSS sounding.
iii. The request may include or be indicated by using a Dialogue Token, where the Dialogue Token identifies an instance of AP2's previous cross-BSS sounding.
   a. For example, it may be the 6-bit Dialogue Token carried in AP2's previous cross-BSS sounding, specifically, in AP2's NDPA or AP2's Beamforming Report Pull (BFRP) frame. The Request with Dialogue Token may indicate that AP1 is requesting a repeat of AP2's previous cross-BSS sounding corresponding to that Dialogue Token, or that AP1 could not decode (at least one) channel measurement report corresponding to AP2's previous cross-BSS sounding with that Dialogue Token.
   b. As described herein, after receiving this indication, should AP2 accept the request, it may be left up to AP2 to determine whether to repeat cross-BSS sounding with the (at least some of the) same STAs that were included in the identified previous cross-BSS sounding, or to pick different STAs for cross-BSS sounding.
   c. Such a request should be made by the AP1 (Inviting AP) within a reasonable time of the AP2's cross-BSS sounding identified by the Dialogue Token. For example, within 20TUs. This is because AP1 may not be expected to remember which associated STAs it had for the identified cross-BSS sounding.
iv. The request may include or be indicated by listing one or more STA AIDs of AP2's STAs for which AP1 is requesting AP2's cross-BSS channel sounding.
   a. The number of STAs that can be listed in an invite frame may be restricted to a small number such as 1 to 3.
   b. This may be seen as the most precise way of requesting other AP's cross-BSS sounding, by identifying individual STAs associated with the other AP (instead of merely identifying an instance of other AP's previous cross-BSS sounding using the Dialogue Token, or identifying the most recent instance using a 1-bit request without the Dialogue Token.)
   c. The STAs (associated with AP2) identified by AP1 in the invite frame may be those for which AP1 could not decode the channel measurement report from AP2's previous cross-BSS sounding, or AP1 may have purged the channel measurement (or precoder information derived from channel measurement) due to memory limitations or implementation timeout logic.
   d. Once again, as describe herein, it may be left up to AP2 to determine which STAs to include in its (AP2's ) next cross-BSS sounding.

Note: The invite frame may include both requests (i.e., request 1 and request 2 described above), only request 1 described above, or only request 2 described above. Request 1 above (if accepted) results in AP1 transmitting a UHR NDPA (with at least one info field address to AP2 for cross-BSS sounding). Request 2 above (if accepted) results in AP2 transmitting a UHR NDPA (with at least one info field address to AP1 for cross-BSS sounding).

AP2 (the AP sending the response frame) may indicate an acceptance decision (e.g., acceptance or rejection) in the response frame for the one or more requests it (AP2) received in the invite frame.
i. The Response frame may be provisioned in such a way that an acceptance decision corresponding to each request can be individually indicated. For example, 2 bits may be provisioned to indicate the acceptance decision. This is a better choice for more flexible and efficient as-needed sounding. Or, the Response frame may provision just 1 bit to indicate accept all requests or reject all requests.
ii. A more advanced design of Response frame is as follows. If the Invite frame from AP1 requested only one cross-BSS sounding, the Response frame may be used to request the other cross-BSS sounding (i.e., the sounding not requested in the Invite frame) if the responding AP incidentally is in need of the other cross-BSS sounding.
   a. For example., suppose AP1's Invite frame requested only one cross-BSS sounding, say, AP1's cross-BSS sounding.
      (A) AP2 through the Response frame could just reject it and that is the end of it.
      (B) AP2 through the Response frame could accept it and not request anything else. Subsequently only one NDPA is transmitted corresponding to the request in the Invite frame, in this case, transmitted by AP1 as the request in the Invite frame was for AP1's cross-BSS sounding.
      (C) AP2 through the Response frame could accept it and, additionally, request the other cross-BSS sounding (in this example, it would be AP2's cross-BSS sounding): Subsequently, both cross-BSS soundings may be performed with each AP transmitting an NDPA.
      If the invite frame requested only AP1's cross-BSS sounding, if AP2 accepts the request, it may use 1 bit in the Response to request addition of AP2's cross-BSS sounding.
      If the invite frame requested only AP2's cross-BSS sounding, if AP2 accepts the request, it may use 1-bit, Dialogue Token, or STA IDs (as described herein) in the Response to request addition of AP1's cross-BSS sounding.
   b. For the advanced design, since the response frame can request an additional cross-BSS sounding, it may be required that the AP sending an Invite frame is prepared for it. For example, the AP sending an Invite frame and requesting only one cross-BSS sounding is implicitly required to be prepared to participate in the other cross-BSS sounding, should the Responding AP request it in the Response frame. This requirement is not any more burdensome than the one imposed by the design that only permits the full/canonical sounding depicted in FIG. 4. Alternatively, a third Confirm frame can be added to the handshake (i.e., Invite->Response->Confirm) as needed, to provide an opportunity to the Inviting AP to accept or reject the additional cross-BSS sounding request brought up by the Responding AP in the Response frame. Yet another alternative is for the Invite frame to indicate if the Inviting AP is open to additional requests from the Responding AP or not.
      1. If the Inviting AP indicates it is open to additional requests, and the Responding AP adds a request for a cross-BSS sounding through the Response frame (the cross-BSS sounding not requested in the Invite frame), the request of the Responding AP is considered accepted by the Inviting AP.
      2. On the other hand, if the Inviting AP indicates it is not open to additional requests, the Responding AP is not allowed to request additional cross-BSS sounding through the Response frame or any additional requests of the Responding AP, made through the Response frame, are considered rejected by the Inviting AP.

As noted above, an AP's cross-BSS sounding starts with the AP sending a UHR NDPA. The AP that is sending the NDPA for cross-BSS sounding may be referred to as the Ordering AP (term “Initiating AP” is being avoided for it may be used elsewhere to sometimes refer to the AP that sent the sounding Invite frame). Assume the Ordering AP is designated AP1. The NDPA contains an info field for the other AP, now called the Ordered AP, to ask it to transmit an NDP for cross-BSS (portion of the) sounding. The Ordered AP's id (such as a partial AID assigned to it during coordination negotiations) appears in this info field of the NDPA. Assume AP2 is the Ordered AP.

AP1's (i.e., the Ordering AP's ) NDPA also carries a STA info list, identifying the associated STAs of AP1 using (partial) AID who are being asked to receive the subsequent NDP and perform an indicated channel measurement. AP1 could include multiple associated STAs in this sounding. Subsequently, AP1 may send one or more BFRP frames to trigger the associated STAs to transmit channel measurements. AP2 (the Ordered AP) needs to decode both BFRPs and the triggered STA's channel measurement reports. For AP2 to correctly acquire all relevant channel measurements a few things are needed:
AP2 may need to know ahead of time how may BFRPs there are going to be. AP1 may inform AP2 of this number in AP1's NDPA (e.g., in one of the info fields addressed to AP2), or in the Invite or Response frame it sent to AP2 (as the case may be, since AP1 could either be the Inviting AP or the Responding AP when AP1's cross-BSS sounding was arranged.) Alternatively, for simple design, number of BFRPs may be fixed to 1.
AP1 may address more associated STAs in its NDPA than AP1 needs AP2 sound. For example, AP1 include STAs for which it is not expecting AP2 to receive and store the channel measurement reports. AP2 may be limited to store, say, only two STA's channel measurements, but AP1 could sound multiple STAs to explore candidates for coordinated transmission with AP2. However, AP1 will shortlist only two STAs for AP2 to store (e.g., shortlisted based on past exploratory soundings.) Therefore, AP1 may need to identify for AP2 the subset of the STAs addressed in the NDPA, the subset for which AP2 is required to decode channel measurement report.
   (a) AP1 may identify the subset of STAs in the NDPA frame, e.g., in an info field addressed to AP2.
   (b) AP1 may be required to put the STAs in the subset first in the STA info list. AP1 can then identify those STAs by indicating “first N STA” (i.e., indicating the number N) to AP2. N may also be fixed to a small number, e.g., 2 or 3. Allowed values of N may be fixed to a small set, e.g., N∈{1,2,‘all’}. The value of N may be indicated in NDPA frame or in the Invite or the Response frame preceding the NDPA.
   (c) AP1 may be required to trigger the channel measurement transmission from the STAs in the subset (i.e., the STAs relevant to AP2 for AP1's cross-BSS sounding) using the first BFRP after the NDP transmission. This way, AP2 will not need to guess or wait for subsequent BFRPs, if any.

BFRP may also include an info field address to AP2 (the Ordered AP).
(a) This info field may indicate if this is the last BFRP of relevance to AP2 or corresponding to this cross-BSS sounding, or if further BFRPs will be transmitted.
(b) This info field may indicate which STAs addressed in the BFRP are relevant to AP2 (i.e., for which AP2 is expected to decode channel measurement report.) E.g., AP1 may indicate the subset of relevant STAs to AP2 (as described herein) in BFRP (e.g., instead of NDPA). E.g., AP1 may be required to put the relevant STAs first in BFRP STA info list, and the number N for “first N STAs” to AP2.

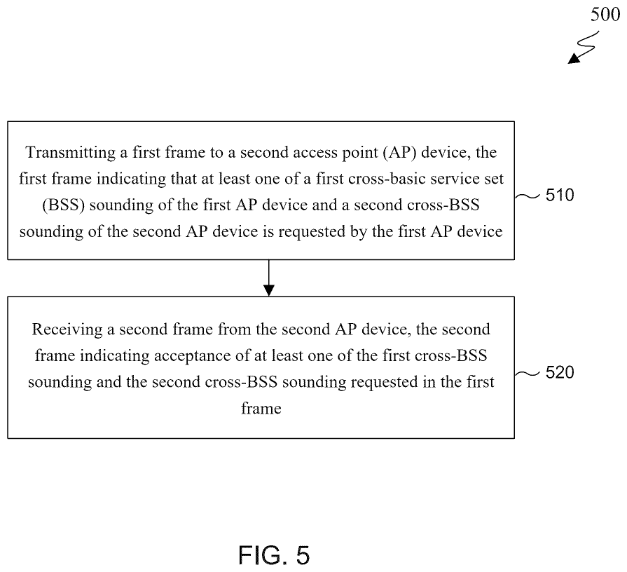

FIG. 5 illustrates an example flow chart of a method 500 for coordination between access points to perform selective channel soundings according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for coordination between access points to perform selective channel soundings could be used without departing from the scope of this disclosure.

As shown in FIG. 5, the method 500 is performed by a first AP device (such as AP device 101 of FIG. 1), and begins at step 510, where the first AP device transmits a first frame to a second AP device (such as AP device 103 of FIG. 1), the first frame indicating that at least one of a first cross-BSS sounding of the first AP device and a second cross-BSS sounding of the second AP device is requested by the first AP device. At step 520, the first AP device receives a second frame from the second AP device, the second frame indicating acceptance of at least one of the first cross-BSS sounding and the second cross-BSS sounding requested in the first frame.

In some embodiments, the first frame includes a sounding invite frame, and the second frame includes a sounding response frame.

In some embodiments, indicating that at least one of the first cross-BSS sounding of the first AP device and the second cross-BSS sounding of the second AP device is requested by the first AP device includes indicating that at least one of a first cross-BSS null data packet announcement (NDPA) of the first AP device and a second cross-BSS NDPA of the second AP device is requested in the first frame; and indicating acceptance of at least one of the first cross-BSS sounding and the second cross-BSS sounding requested in the first frame includes indicating that at least one of the first cross-BSS NDPA of the first AP device and the second cross-BSS NDPA of the second AP device is accepted.

In some embodiments, when the first frame indicates that only the first cross-BSS NDPA of the first AP device is requested, the first AP device receives, from the second AP device, a request for the second cross-BSS NDPA of the second AP device.

In some embodiments, when the first frame indicates that only the second cross-BSS NDPA of the second AP device is requested, the first AP device receives, from the second AP device, a request for the first cross-BSS NDPA of the first AP device.

In some embodiments, the first frame indicates that the first AP device wants to transmit a first cross-BSS null data packet announcement (NDPA) to the second AP device, or the first frame indicates a request for the second AP device to transmit a second cross-BSS NDPA to the first AP device.

In some embodiments, indicating the request for the second AP device to transmit the second cross-BSS NDPA to the first AP device comprises at least one of: indicating a request to repeat a previous cross-BSS NDPA; indicating a request for an NDPA for which the first AP device failed to decode corresponding channel state information (CSI); and indicating a request for a station (STA) identification (ID) for a STA associated with the second AP device for which the first AP device wants to acquire CSI. Acquiring CSI may be for updating CSI, for acquiring CSI that the first AP failed to decode, or for acquiring CSI that the first AP device had to purge, e.g., for memory management.

Although FIG. 5 illustrates an example flow chart of a method 500 for coordination between access points to perform selective channel soundings, various changes may be made to FIG. 5. For example, while shown as a series of steps, various steps in FIG. 5 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a first access point (AP) device, the method comprising:
transmitting a first frame to a second AP device, the first frame indicating that at least one of a first cross-basic service set (BSS) sounding of the first AP device and a second cross-BSS sounding of the second AP device is requested by the first AP device; and
receiving a second frame from the second AP device, the second frame indicating acceptance of at least one of the first cross-BSS sounding and the second cross-BSS sounding requested in the first frame.

2. The method of claim 1, wherein:
the first frame includes a sounding invite frame; and
the second frame includes a sounding response frame.

3. The method of claim 1, wherein:
indicating that at least one of the first cross-BSS sounding of the first AP device and the second cross-BSS sounding of the second AP device is requested by the first AP device includes indicating that at least one of a first cross-BSS null data packet announcement (NDPA) of the first AP device and a second cross-BSS NDPA of the second AP device is requested in the first frame; and
indicating acceptance of at least one of the first cross-BSS sounding and the second cross-BSS sounding requested in the first frame includes indicating that at least one of the first cross-BSS NDPA of the first AP device and the second cross-BSS NDPA of the second AP device is accepted.

4. The method of claim 3, further comprising when the first frame indicates that only the first cross-BSS NDPA of the first AP device is requested, receiving, from the second AP device, a request for the second cross-BSS NDPA of the second AP device.

5. The method of claim 3, further comprising when the first frame indicates that only the second cross-BSS NDPA of the second AP device is requested, receiving, from the second AP device, a request for the first cross-BSS NDPA of the first AP device.

6. The method of claim 1, wherein:
the first frame indicates that the first AP device wants to transmit a first cross-BSS null data packet announcement (NDPA) to the second AP device, or
the first frame indicates a request for the second AP device to transmit a second cross-BSS NDPA to the first AP device.

7. The method of claim 6, wherein indicating the request for the second AP device to transmit the second cross-BSS NDPA to the first AP device comprises at least one of:
indicating a request to repeat a previous cross-BSS NDPA;
indicating a request for an NDPA for which the first AP device failed to decode corresponding channel state information (CSI); and
indicating a request for a station (STA) identification (ID) for a STA associated with the second AP device for which the first AP device wants to acquire CSI.

8. A method performed by a second access point (AP) device, the method comprising:
receiving a first frame from a first AP device, the first frame indicating that at least one of a first cross-basic service set (BSS) sounding of the first AP device and a second cross-BSS sounding of the second AP device is requested by the first AP device; and
transmitting a second frame to the first AP device, the second frame indicating acceptance of at least one of the first cross-BSS sounding and the second cross-BSS sounding requested in the first frame.

9. The method of claim 8, wherein:
the first frame includes a sounding invite frame; and
the second frame includes a sounding response frame.

10. The method of claim 8, wherein:
indicating that at least one of the first cross-BSS sounding of the first AP device and the second cross-BSS sounding of the second AP device is requested by the first AP device includes indicating that at least one of a first cross-BSS null data packet announcement (NDPA) of the first AP device and a second cross-BSS NDPA of the second AP device is requested in the first frame; and
indicating acceptance of at least one of the first cross-BSS sounding and the second cross-BSS sounding requested in the first frame includes indicating that at least one of the first cross-BSS NDPA of the first AP device and the second cross-BSS NDPA of the second AP device is accepted.

11. The method of claim 10, further comprising when the first frame indicates that only the first cross-BSS NDPA of the first AP device is requested, transmitting, to the first AP device, a request for the second cross-BSS NDPA of the second AP device.

12. The method of claim 10, further comprising when the first frame indicates that only the second cross-BSS NDPA of the second AP device is requested, transmitting, to the first AP device, a request for the first cross-BSS NDPA of the first AP device.

13. The method of claim 8, wherein:
the first frame indicates that the first AP device wants to transmit a first cross-BSS null data packet announcement (NDPA) to the second AP device, or
the first frame indicates a request for the second AP device to transmit a second cross-BSS NDPA to the first AP device.

14. The method of claim 13, wherein indicating the request for the second AP device to transmit the second cross-BSS NDPA to the first AP device comprises at least one of:
indicating a request to repeat a previous cross-BSS NDPA;
indicating a request for an NDPA for which the first AP device failed to decode corresponding channel state information (CSI); and
indicating a request for a station (STA) identification (ID) for a STA associated with the second AP device for which the first AP device wants to acquire CSI.

15. A first access point (AP) device comprising:
at least one processor including processing circuitry; and
memory storing instructions, wherein the instructions, when executed by the at least one processor individually or collectively, cause the first AP device to:
transmit a first frame to a second AP device, the first frame indicating that at least one of a first cross-basic service set (BSS) sounding of the first AP device and a second cross-BSS sounding of the second AP device is requested by the first AP device; and
receive a second frame from the second AP device, the second frame indicating acceptance of at least one of the first cross-BSS sounding and the second cross-BSS sounding requested in the first frame.

16. The first AP device of claim 15, wherein:
the first frame includes a sounding invite frame; and
the second frame includes a sounding response frame.

17. The first AP device of claim 15, wherein:
to indicate that at least one of the first cross-BSS sounding of the first AP device and the second cross-BSS sounding of the second AP device is requested by the first AP device, the instructions, when executed by the at least one processor individually or collectively, cause the first AP device to indicate that at least one of a first cross-BSS null data packet announcement (NDPA) of the first AP device and a second cross-BSS NDPA of the second AP device is requested in the first frame, and
to indicate acceptance of at least one of the first cross-BSS sounding and the second cross-BSS sounding requested in the first frame, the instructions, when executed by the at least one processor individually or collectively, cause the first AP device to indicate that at least one of the first cross-BSS NDPA of the first AP device and the second cross-BSS NDPA of the second AP device is accepted.

18. The first AP device of claim 17, wherein the instructions, when executed by the at least one processor individually or collectively, cause the first AP device to:
when the first frame indicates that only the first cross-BSS NDPA of the first AP device is requested, receive, from the second AP device, a request for the second cross-BSS NDPA of the second AP device.

19. The first AP device of claim 17, wherein the instructions, when executed by the at least one processor individually or collectively, cause the first AP device to:
when the first frame indicates that only the second cross-BSS NDPA of the second AP device is requested, receive, from the second AP device, a request for the first cross-BSS NDPA of the first AP device.

20. The first AP device of claim 15, wherein:
the first frame indicates that the first AP device wants to transmit a first cross-BSS null data packet announcement (NDPA) to the second AP device, or
the first frame indicates a request for the second AP device to transmit a second cross-BSS NDPA to the first AP device.
